(19) United States
(12) Patent Application Publication
(10) Pub. No.: US 2025/0123439 A1
(43) Pub. Date: Apr. 17, 2025

(54) FRONT LIGHT MODULE AND REFLECTIVE DISPLAY DEVICE

(71) Applicant: E Ink Holdings Inc., HSINCHU (TW)

(72) Inventors: Chung Guang CHEN, HSINCHU (TW); Jen-Shiun HUANG, HSINCHU (TW); Hsin-Tao HUANG, HSINCHU (TW)

(21) Appl. No.: 18/780,506

(22) Filed: Jul. 23, 2024

(30) Foreign Application Priority Data
Oct. 11, 2023 (TW) 112138812

(51) Int. Cl. F21V 8/00

(52) U.S. Cl. CPC G02B 6/0038; G02B 6/0055; G02B 6/0068

(57) ABSTRACT

A front light module which includes a light guide plate, a light-emitting component and a barrier layer is provided. The light guide plate has a light incident surface and a light exiting surface which is adjacent to the light incident surface, and the light-emitting component emits the light toward the light incident surface. The barrier layer which includes the materials with silicon bonding is located on the light exiting surface of the light guide plate. The water vapor transmission rate of the barrier layer is lower than 0.1 g/m²/day.

### RELATED APPLICATIONS

This application claims priority to Taiwan Application Serial Number 112138812, filed Oct. 11, 2023, which is herein incorporated by reference in its entirety.

### BACKGROUND

### Technical Field

The present disclosure relates to a front light module and a reflective display device using this front light module. More particular, the present disclosure relates to the front light module with high resistance to water vapor.

### Description of Related Art

The light guide plate of the light-emitting module in electronic paper is prevented from water vapor by a barrier film which is disposed between the light guide plate and the display panel. In general, the barrier film is located between the light guide plate and the display panel, and the barrier film should be adhered to the light guide plate and the display panel through at least two optical clear adhesives. However, the thickness of the barrier film and the optical clear adhesives are limited, so that the development for a thinner and lighter light-emitting module is restricted. Moreover, the transmittance of the light passing through the light guide plate is reduced by the barrier film and the optical clear adhesives, thereby affecting the luminous efficiency of the front light module.

### SUMMARY

Accordingly, the disclosure is to provide a front light module. The thickness of this front light module may be reduced while the front light module is resistant to water vapor.

At least one embodiment of the disclosure provides a front light module including a light guide plate, a light-emitting component and a first barrier layer. The light guide plate has a light incident surface and a first light exiting surface adjacent to the light entering surface, and the light-emitting component emits a light toward the light incident surface. The first barrier layer is located on the first light exiting surface of the light guide plate and includes a silicon chain material. The water vapor transmission rate (WVTR) of the first barrier layer is less than 0.1 g/m²/day.

At least in one embodiment of the disclosure, a main chain of the silicon chain material is selected from the group consisting of silicon nitrogen bonds and silicon oxygen bonds.

At least in one embodiment of the disclosure, the thickness of the first barrier layer ranges from 200 nm to 1000 nm.

At least in one embodiment of the disclosure, the refractive index of the first barrier layer is less than the refractive index of the guide light plate.

At least in one embodiment of the disclosure, the refractive index of the first barrier layer ranges from 1.40 to 1.55.

At least in one embodiment of the disclosure, the front light module further includes a second barrier layer located on the second light exiting surface of the light guide plate. The second light exiting surface and the first light exiting surface are located on two opposite sides of the light guide plate, and the second barrier layer includes the silicon chain material. The WVTR of the second barrier layer is less than 0.1 g/m²/day.

At least in one embodiment of the disclosure, the refractive index of the second barrier layer is less than the refractive index of the light guide plate.

At least in one embodiment of the disclosure, the refractive index of the second barrier layer is greater than the refractive index of the first barrier layer.

At least in one embodiment of the disclosure, the refractive index of the light guide plate ranges from 1.49 to 1.59.

At least in one embodiment of the disclosure, the front light module further includes two third barrier layers separately located on two opposite side surfaces of the light guide plate. The side surfaces are adjacent to the light incident surface separately and are adjacent to the first light exiting surface separately. The third barrier layers include the silicon chain material, and the WVTR of the third barrier layers is less than 0.1 g/m²/day.

At least in one embodiment of the disclosure, the thicknesses of the third barrier layers range from 200 nm to 1000 nm.

At least in one embodiment of the disclosure, the front light module further includes a protective layer located on the first light exiting surface of the light guide plate.

At least in one embodiment of the disclosure, the first barrier layer is formed on the light guide plate by wet coating.

An embodiment of the disclosure provides a reflective display device including the aforementioned front light module and a reflective display panel disposed opposite to the front light module.

At least in one embodiment of the disclosure, the first barrier layer of the front light module backs on to a display surface of the reflective display panel.

According to the aforementioned embodiments, the first barrier layer, the second barrier layer and the third barrier layers resistant to water vapor are formed on the light guide plate by coating. Since those barrier layers are disposed on the light guide plate without optical clear adhesive, the light guide plate is prevented from deformation due the water vapor under the circumstance that the effects on the thickness and optical properties of the front light module are reduced.

### BRIEF DESCRIPTION OF THE DRAWINGS

To illustrate more clearly the aforementioned and the other objects, features, merits, and embodiments of the present disclosure, the description of the accompanying figures are as follows:

FIG. 1 illustrates a locally cross-sectional view of a front light module in accordance with one embodiment of the present disclosure;

FIG. 2 illustrates a locally cross-sectional view of a front light module in accordance with another embodiment of the present disclosure;

FIG. 3 illustrates a locally stereographic view of a front light module in accordance with another embodiment of the present disclosure;

FIG. 4 illustrates a schematic view of a reflective display device in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−30%, +/−20%, +/−10% or +/−5% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

FIG. 1 illustrates the front light module 100 in accordance with one embodiment of the present disclosure, and the front light module 100 includes the light-emitting component 110, the light guide plate 120 and the first barrier layer 140. The light guide plate 120 has the light incident surface 120a and the first light exiting surface 120f which is adjacent to the light incident surface 120a. The light-emitting component 110 is located on one side of the light guide plate 120 and emits the light L1 toward the light incident surface 120a.

As shown in FIG. 1, the light L1 enters the light guide plate 120 through the light incident surface 120a and then transmits through the light guide plate 120. Partial of the light L1 exits the light guide plate 120 by the first light exiting surface 120f, while another partial of the light L1 exits the light guide plate 120 by the second light exiting surface 120s. The first light exiting surface 120f and the second light exiting surface 120s are located on two opposite sides of the light guide plate 120.

The light-emitting component 110 may be an electroluminescent component such as a light-emitting diode (LED). For instance, the light-emitting component 110 may be a light bar which has a plurality of LEDs in this embodiment. On the other hand, the materials of the light guide plate 120 may include Polymethylmethacrylate (PMMA), Polycarbonate (PC), Methylmethacrylate-Styrene (MS) resin or similar polymers thereof.

Although the front light module 100 of this embodiment only includes one light-emitting component 110, and this light-emitting component 110 is located on one side of the light guide plate 120, the disclosure is not limited to the embodiment. In other embodiments, the front light module 100 may include more than one light-emitting component 110. For example, the front light module 100 may include two light-emitting components 110 which are located on two opposite sides of the light guide plate 120 separately. One of the light-emitting components 110 emits the light L1 toward the light incident surface 120a of the light guide plate 120, while the other one of the light-emitting components 110 emits the light (not shown) toward the other light incident surface 120b of the light guide plate 120.

Referring to FIG. 1, the first barrier layer 140 is located on and completely covers the first light exiting surface 120f of the light guide plate 120. The first barrier layer 140 includes the silicon chain material, and the main chain of this silicon chain material is consisting of silicon nitrogen bonds, silicon oxygen bonds or the combination thereof. Furthermore, in the embodiment, the first barrier layer 140 may be formed on the first light exiting surface 120f of the light guide plate 120 directly by methods such as wet coating and surficial modification. However, the method for forming the first barrier layer 140 of the disclosure is not limited to the embodiment, but other coating methods may be included.

The first barrier layer 140 may include materials which are formed with high compaction, such as ceramic materials, so that the WVTR of the first barrier layer 140 is less than 0.1 g/m²/day. As a result, the contact between the water vapor of environment and the light guide plate 120 may be restrained, thereby preventing the light guide plate 120 from deformation due to water vapor. In addition, the first barrier layer 140 further has high transmittance of light. For instance, the transmittance of light of the first barrier layer 140 is higher than 85% in this embodiment. Thus, the light loss which is caused by the first barrier layer 140 can be reduced, so that the luminous efficiency of the front light module 100 is increased.

It is worth mentioning, in some of the embodiments of the disclosure, the thickness of the first barrier layer 140 ranges from 200 nm to 1000 nm. However, the disclosure is not limited to the embodiments. Furthermore, the refractive index of the first barrier layer 140 is less than the refractive index of the light guide plate 120. For example, in this embodiment, the refractive index of the first barrier layer 140 ranges from 1.40 to 1.55, while the refractive index of the light guide plate 120 ranges from 1.49 to 1.59.

As a result, the probability of the total internal reflection (TIR) that occurs on the interface between the first barrier layer 140 and the light guide plate 120 (i.e. the first light exiting surface 120f) where the light L1 passing through increases, so that the light transmittance is improved. However, the refractive index of the first barrier layer 140 and the refractive index of the light guide plate 120 are not limited to the aforementioned embodiment.

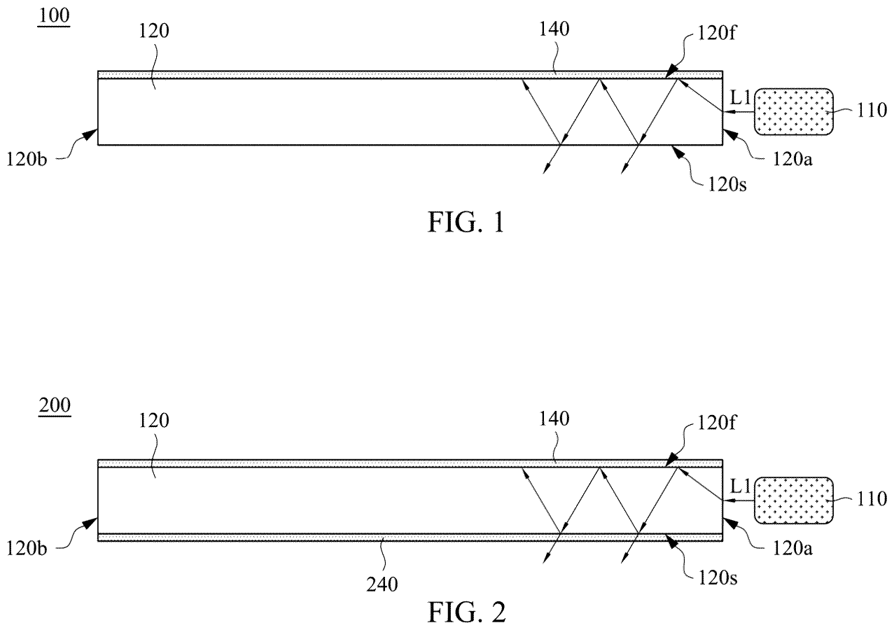

FIG. 2 illustrates the front light module 200 in accordance with another embodiment of the present disclosure which is similar to the front light module 100. The difference between the front light module 100 and the front light module 200 is that the front light module 200 further includes the second barrier layer 240. The second barrier layer 240 is located on the second light exiting surface 120s of the light guide plate 120, while the second light exiting surface 120s and the first light exiting surface 120f are located on two opposite sides of the light guide plate 120 separately. That is, the first barrier layer 140 and the second barrier layer 240 are located on two opposite sides of the light guide plate 120 separately.

It is worth mentioning, the material of the second barrier layer 240 may be similar to or be the same as the material of the first barrier layer 140. For example, the second barrier layer 240 may include the silicon chain material, and the main chain of this silicon chain material is consisting of silicon nitrogen bonds, silicon oxygen bonds or the combination thereof. In addition, since the materials of the second barrier layer 240 and the first barrier layer 140 are similar or the same, the WVTR of the second barrier layer 240 is less than 0.1 g/m²/day.

It is worth mentioning, in some embodiments of the disclosure, the thickness of the second barrier layer 240 ranges from 200 nm to 1000 nm, but the disclosure is not limited to the embodiment. Furthermore, in this embodiment, the refractive index of the second barrier layer 240 is less than the refractive index of the light guide plate 120 but higher than the refractive index of the first barrier layer 140. Specifically, while the refractive index of the light guide plate 120 ranges from 1.49 to 1.59 (e.g. 1.59), the refractive indexes of the first barrier layer 140 and the second barrier layer 240 range from 1.40 to 1.55. The refractive index of the first barrier layer 140 may be 1.45, and the refractive index of the second barrier layer 240 may be 1.55.

As a result, the probability of the total internal reflection that occurs on the interface between the first barrier layer 140 and the light guide plate 120 (i.e. the first light exiting surface 120f) and on the interface between the second barrier layer 240 and the light guide plate 120 (i.e. the second light exiting surface 120s) where the light L1 passing through increases, so that the light transmittance is improved. However, the refractive index of the first barrier layer 140, the refractive index of the second barrier layer 240 and the refractive index of the light guide plate 120 are not limited to the aforementioned embodiment. For instance, the refractive index of the first barrier layer 140 may be the same as the refractive index of the second barrier layer 240.

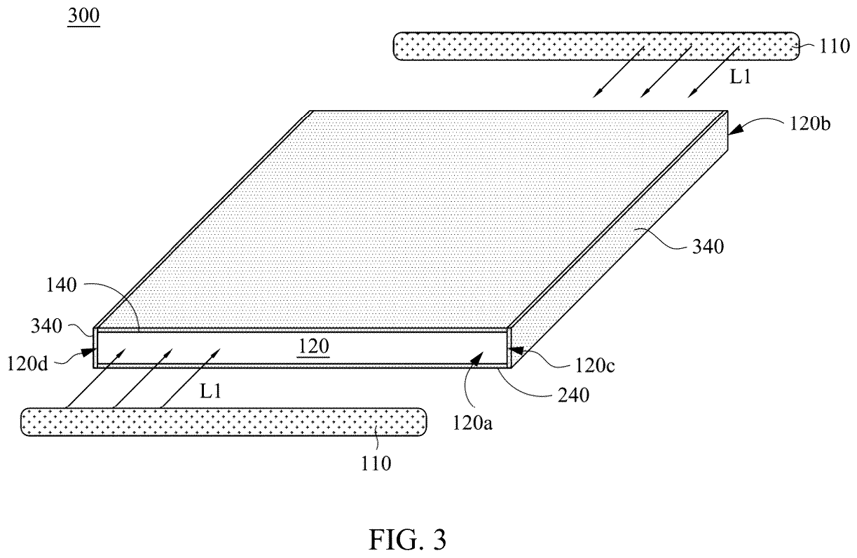

FIG. 3 illustrates the front light module 300 in accordance with another embodiment of the present disclosure which is similar to the front light module 100. The difference between the front light module 100 and the front light module 300 is that the front light module 300 further includes two third barrier layers 340, and these third barrier layers 340 are located on two opposite side surfaces of the light guide plate 120 separately. Specifically, one of the third barrier layers 340 is located on one side surface 120c of the light guide plate 120, while the other one of the third barrier layers 340 is located on the other side surface 120d of the light guide plate 120. It is worth mentioning, in this embodiment, the front light module 300 includes two light-emitting components 110, and these two light-emitting components 110 are located on the light incident surface 120a and the light incident surface 120b of the light guide plate 120 separately.

As shown in FIG. 3, the side surface 120c and the side surface 120d are adjacent to the light incident surface 120a (and the light incident surface 120b) separately and are adjacent to the first light exiting surface 120f (and the second light exiting surface 120s) separately. In other words, the first barrier layer 140, the second barrier layer 240 and two third barrier layers 340 are respectively located on and cover four surfaces which are opposite to each other in pairs. Those aforementioned barrier layers do not cover the light incident surface 120a and the light incident surface 120b. That is, the six surfaces of the light guide plate 120 correspond to the four barrier layers and two light-emitting components respectively.

The materials of the third barrier layers 340 may be similar to or be the same as the material of the first barrier layer 140. For example, the third barrier layers 340 may include the silicon chain material, and the main chain of this silicon chain material is consisting of silicon nitrogen bonds, silicon oxygen bonds or the combination thereof. In addition, since the materials of the third barrier layers 340 and the first barrier layer 140 are similar or the same, the WVTR of the third barrier layers 340 is less than 0.1 g/m²/day.

In some embodiments of the disclosure, the thicknesses of the third barrier layers 340 range from 200 nm to 1000 nm, but the disclosure is not limited to those embodiments. Furthermore, in this embodiment, the refractive indexes of the third barrier layers 340 are less than the refractive index of the light guide plate 120. Specifically, while the refractive index of the light guide plate 120 ranges from 1.49 to 1.59 (e.g. 1.59), the refractive indexes of the third barrier layers 340 range from 1.40 to 1.55. As a result, the probability of the total internal reflection that occurs on the interface between the third barrier layers 340 and the light guide plate 120 (i.e. the side surface 120c and the side surface 120d) where the light L1 passing through is increased, so that the light transmittance is improved.

In some embodiments of the disclosure, the front light module (e.g. the front light module 100) may further include a cover lens which is not illustrated in figures. This cover lens is located on the first light exiting surface 120f of the light guide plate 120 to protect the first light exiting surface 120f of the light guide plate 120, thereby enhancing the resistance against scratching of the front light module.

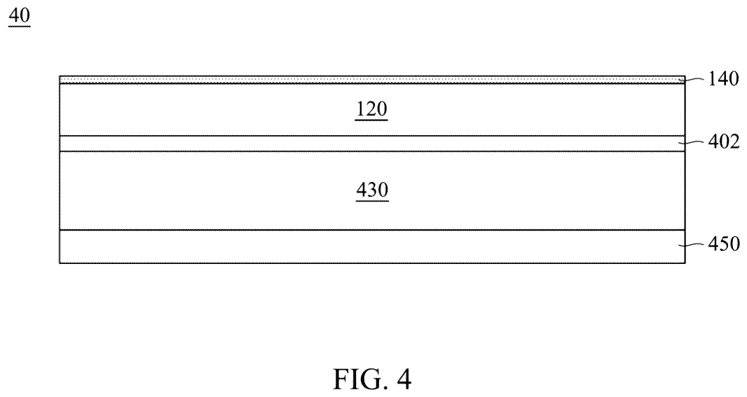

FIG. 4 illustrates the schematic view of the reflective display device 40 in accordance with one embodiment of the present disclosure. The reflective display device 40 includes the front light module 100 and the reflective display panel 430 which is disposed opposite to the front light module 100. The reflective display panel 430 may be an electrophoretic display (EPD) panel, a cholesteric liquid crystal display (ChLCD) panel or a similar panel thereof. In addition, the front light module of the reflective display device 40 is not limited to the front light module 100. That is, the front light module of the reflective display device 40 may be the front light module 200 or the front light module 300.

The reflective display device 40 further includes the pixel arrays substrate 450, and the pixel arrays substrate 450 may be a thin film transistor (TFT) substrate or a similar transistor substrate thereof. As shown in FIG. 4, the reflective display panel 430 is disposed on the pixel arrays substrate 450 and located between the pixel arrays substrate 450 and the front light module 100.

In the embodiment, the first barrier layer 140 of the front light module 100 backs on to the display surface 430s of the reflective display panel 430. Furthermore, the front light module 100 is adhered to the display surface 430s of the reflective display panel 430 through the optical clear adhesive (OCA) 402.

In conclusion, the barrier layers (e.g. the first barrier layer 140, the second barrier layer 240 and the third barrier layers 340) with low WVTR are disposed on the light guide plate of this disclosure, so that the contact between the water vapor of environment and the light guide plate may be reduced, thereby preventing the light guide plate from deformation due to water vapor. Moreover, since the aforementioned barrier layers may be formed on the surface of the light guide plate by coating process, the optical clear adhesive for adhesion of the barrier layers and the light guide plate can be omitted. Therefore, once the barrier layers are disposed on the front light module for water vapor resistance, the thickness of the light front module is not increased due to the thickness of the optical clear adhesive. On the other hand, the aforementioned barrier layers further has high transmittance of light (e.g. the transmittance of light of the first barrier layer 140 is higher than 85%), thereby reducing the effect on luminous efficiency of the front light module which is caused by the barrier layers.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A front light module comprising:
a light guide plate having a light incident surface and a first light exiting surface adjacent to the light entering surface;
a light-emitting component emitting a light toward the light incident surface; and
a first barrier layer located on the first light exiting surface of the light guide plate, wherein the first barrier layer comprises a silicon chain material, and a water vapor transmission rate (WVTR) of the first barrier layer is less than 0.1 g/m²/day.

2. The front light module of claim 1, wherein a main chain of the silicon chain material is selected from the group consisting of silicon nitrogen bonds and silicon oxygen bonds.

3. The front light module of claim 1, wherein a thickness of the first barrier layer ranges from 200 nm to 1000 nm.

4. The front light module of claim 1, wherein a refractive index of the first barrier layer is less than a refractive index of the guide light plate.

5. The front light module of claim 4, wherein the refractive index of the first barrier layer ranges from 1.40 to 1.55.

6. The front light module of claim 1, further comprising:
a second barrier layer located on the second light exiting surface of the light guide plate, wherein the second light exiting surface and the first light exiting surface are located on two opposite sides of the light guide plate, and the second barrier layer comprises the silicon chain material, and a WVTR of the second barrier layer is less than 0.1 g/m²/day.

7. The front light module of claim 6, wherein a refractive index of the second barrier layer is less than a refractive index of the light guide plate.

8. The front light module of claim 7, wherein the refractive index of the second barrier layer is greater than a refractive index of the first barrier layer.

9. The front light module of claim 8, wherein the refractive index of the light guide plate ranges from 1.49 to 1.59.

10. The front light module of claim 1, further comprising:
two third barrier layers separately located on two opposite side surfaces of the light guide plate, wherein the side surfaces are adjacent to the light incident surface separately and are adjacent to the first light exiting surface separately, wherein the third barrier layers comprise the silicon chain material, and the WVTR of the third barrier layers is less than 0.1 g/m²/day.

11. The front light module of claim 10, wherein thicknesses of the third barrier layers range from 200 nm to 1000 nm.

12. The front light module of claim 1, further comprising:
a protective layer located on the first light exiting surface of the light guide plate.

13. The front light module of claim 1, wherein the first barrier layer is formed on the light guide plate by wet coating.

14. A reflective display device, comprising:
a front light module of claim 1; and
a reflective display panel disposed opposite to the front light module.

15. The reflective display device of claim 14, wherein the first barrier layer of the front light module backs on to a display surface of the reflective display panel.
